(19) United States
(12) Patent Application Publication
(10) Pub. No.: US 2012/0074702 A1
(43) Pub. Date: Mar. 29, 2012

(54) Appratus generating electricity to marine vehicle

(76) Inventor: Ned M. Ahdoot, Rancho Palos Verdes, CA (US)

(21) Appl. No.: 13/317,976

(22) Filed: Nov. 2, 2011

Related U.S. Application Data
(63) Continuation-in-part of application No. 11/788,528, filed on Apr. 19, 2007, now Pat. No. 7,980,832.

(51) Int. Cl. F03B 13/12

(52) U.S. Cl. 290/53

(57) ABSTRACT

An apparatus for producing electrical usable energy to be deployed on a solid ground or on a vessel while the vessel is in stationary position or in motion, moving from one place to another. The apparatus converts two or three dimensional reciprocating linear mechanical motions into rotational motion and thus electricity. The apparatus comprising of an energy converter part and plurality of energy capturing part that absorbs two or three dimensional linear mechanical motions power of ocean water and converts it to electricity.

### CROSS-REFERENCE TO RELATED APPLICATIONS

This application is continuation in part of the application Ser. No. 11/788,528

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”, KMM

Not applicable.

This application is continuation in part of the application Ser. No. 11/788,528

### BACKGROUND OF THE INVENTION

### Field of the Present Disclosure

This disclosure relates generally to machines for harnessing ocean wave movement to create useful work for the generation of electricity for marine vehicles.

William Walter Hirsch, U.S. Pat. No. 7,199,481 B2 Wave Energy Conversion Systems.

Frank Burick U.S. Pat. No. 7,365,445 B2 Apparatus for converting ocean wave energy to electrical energy.

Stephen J. Sadig U.S. Pat. No. 6,812,588 B1 Wave Energy Converter.

Fred Ernest Gardener U.S. Pat. No. 5,909,060 Wave Energy Transformer.

Dreck Woollatt U.S. Pat. No. 5,647,730 Self-Contained Clearance Volume Adjustment Means for a Gas Compressor.

Tzong et el U.S. Pat. No. 5,186,822 Wave Powered Desalinization With Turbine Driven Pressurization.

Ernest p. Rubi U.S. Pat. No. 4,851,704 Wave Action Electricity Generation System and Method.

Don E Rainey U.S. Pat. No. 4,208,878 Ocean Tide Energy Converter.

Kumbativc bougmil U.S. Pat. No. 5,311,064

Navorro Pablo U.S. Pat. No. 4,228,360

Holmes William U.S. Pat. No. 4,627,240

Youngblood George U.S. Pat. No. 5,359,229

The related art described above discloses apparatus and methods for converting water motion and weight to useful energy. However, the prior art fails to disclose the presently described energy capturing system having the ability to be adapted to convert the energy generated by movement of a marine vessel while in water. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The apparatus is deployed on a solid ground or on a naval vessel while the vessel is in stationary position or in motion. Besides the naval vessel, at least five other embodiment of the invention utilizing the conversion methodology is introduced. The apparatus converts two dimensional reciprocating linear mechanical motions into rotational motion and thus electricity. It comprises of an energy converter part that converts mechanical linear power into rotational power and thus electricity, and plurality of energy capturing parts that absorbs three dimensional or two dimensional linear mechanical motional from a natural entity of ocean water or wind. The energy converter part connected to the energy capturing parts via a rigid or semi rigid transfer media for transfer of reciprocating motions that will be converted to axial rotational motions. The reciprocating motions will cause rotational motions in only one direction, by means of a ratchet wheel connected to a shaft and an electric generator. A flywheel connected to the shaft and the turbine will provide regulation of mechanical power to the turbine.

A primary objective inherent in the above described apparatus and method of use is to provide advantages not taught by the prior art.

A still further objective is to provide such a system that is fully automated in its operation.

Other features and advantages of the present invention will become apparent from the following more detailed description, taken in conjunction with the accompanying drawings, which illustrate, by way of example, the principles of the presently described apparatus and method of its use.

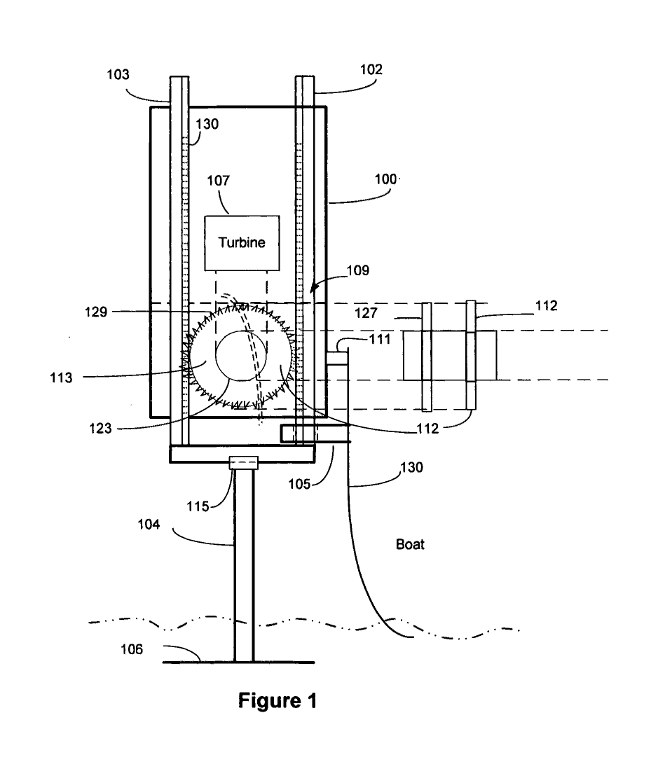

FIG. 1: is the embodiment of the converter to power vessels while it is anchored to ground or in motion.

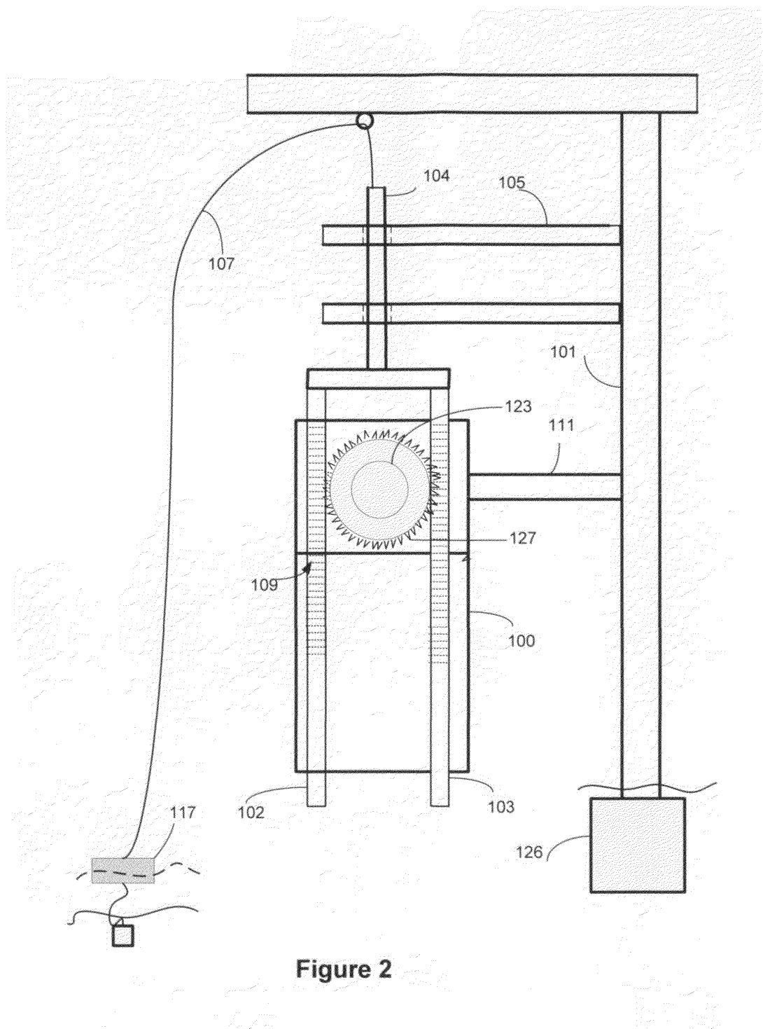

FIG. 2: is a slightly different embodiment of the converter embodiment of the converter to power a home or a boat.

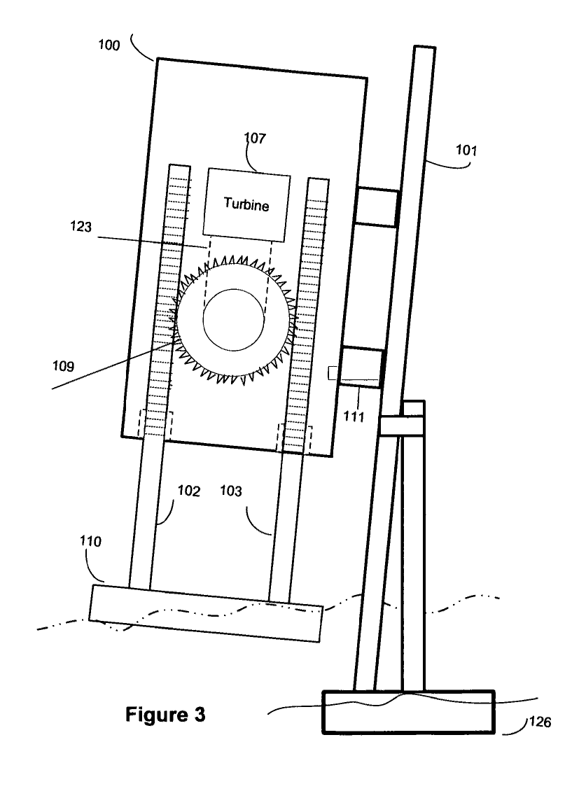

FIG. 3: is a slight different embodiment of the converter to power homes or small businesses along shores.

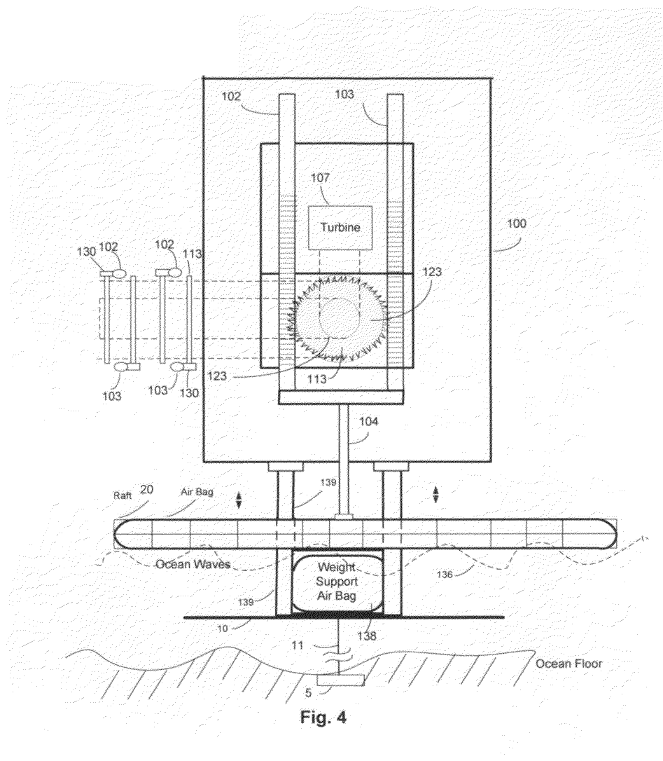

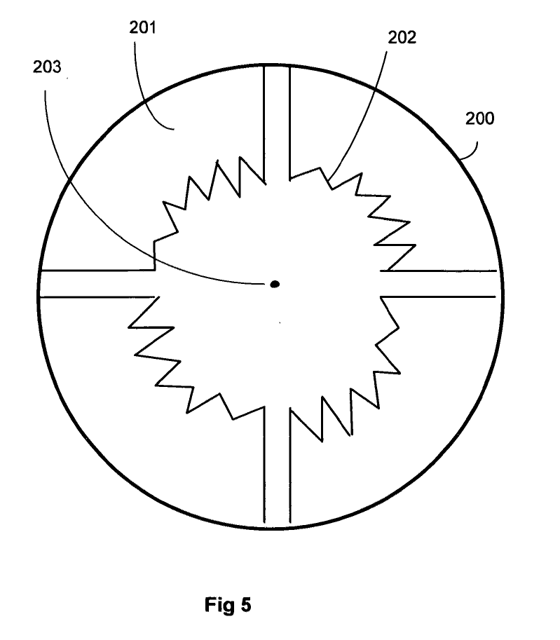

FIG. 4: is an embodiment for deploying the apparatus on the middle of ocean with multiple energy capturing devices

FIG. 5: is a method for maximizing the energy capturing of floatable buoyant body.

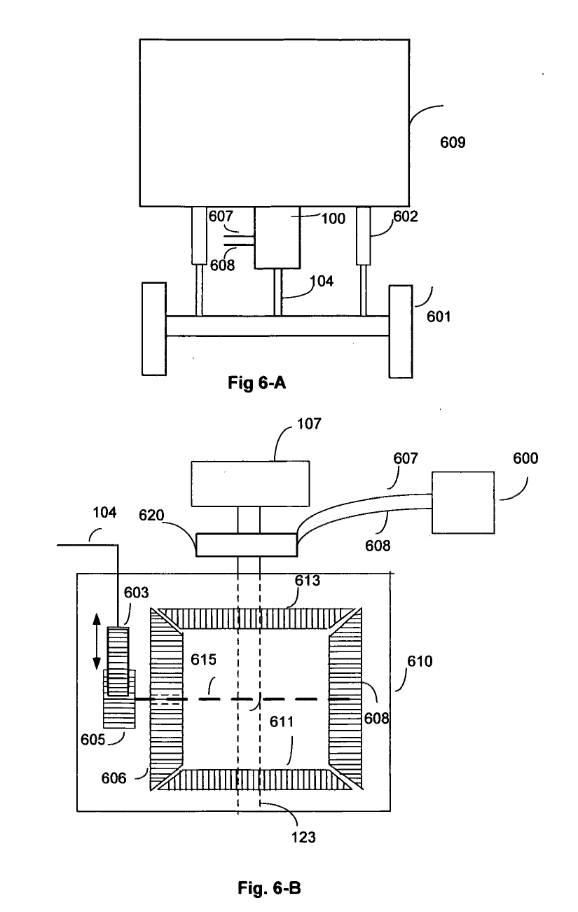

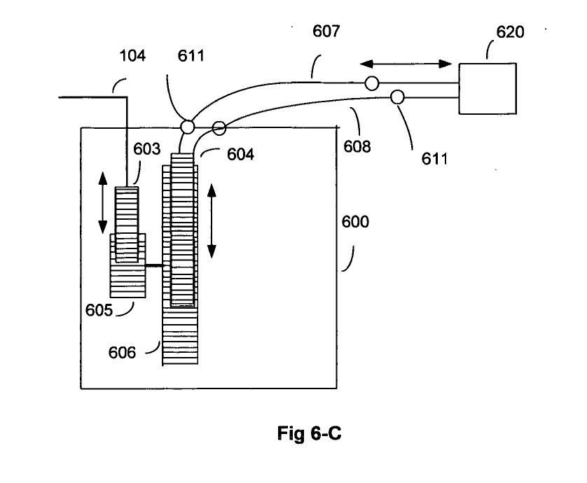

FIG. 6A: are embodiments of the converter to convert energy from linear motions of the land vehicle frame with respect to the motions of tires.

FIG. 6B: is the embodiment of the converter to convert energy from one of the wheels of the vehicle.

FIG. 6C: is the embodiment of the converter to convert energy from the remaining of the wheels of the vehicle.

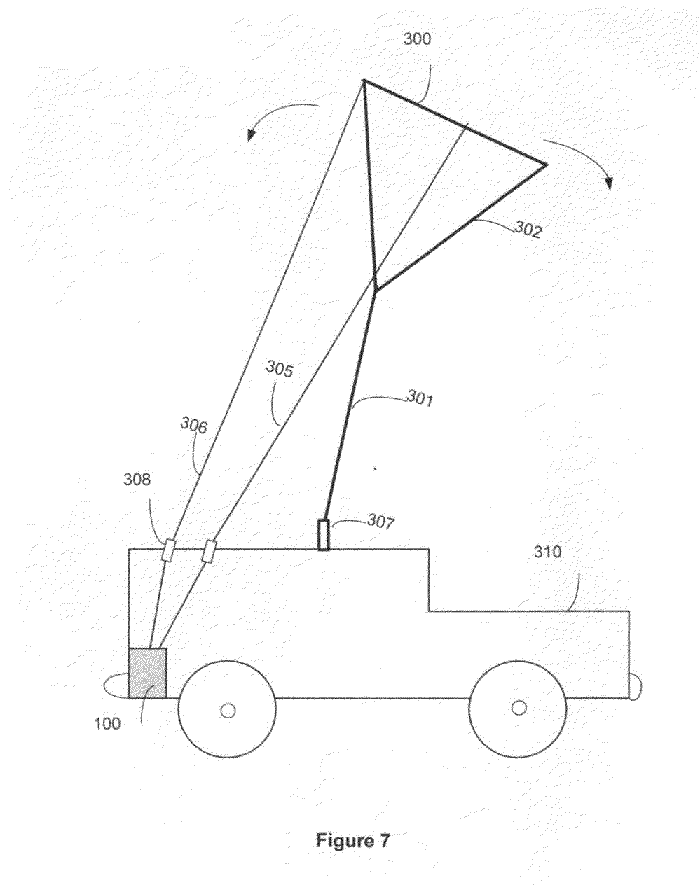

FIG. 7: is an embodiment for deploying the apparatus on the ground or on a mobile vehicle to extract energy from the wind.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

The FIG. 1 depicts the converter frame 100 deployed on a marine vehicle 130. The energy capturing part is a buoyant body 106, is a floating plate immersed in the water to provide the reciprocating motion; the plate is connected to a rod 104 perpendicular to the plate surface. The rod 104 is also connected to second set of U shape two rods 102 and 103; a pair of rectangular blades with slots 130 is attached to both set of the second rods with slots. The rod 104 is guided by mechanical support 105 connected to the body of the marine vehicle to allow the rod to move in same direction of the vessel with the exception that the rod 104 and the plate 106 will move up and down in a shorter distances than the motion distance of the vessel. The difference between the two motions is the basis and the reason for delivering reciprocating motion to the converter. The converter translates this reciprocating motion to a rotational motion and electricity.

Refereeing again to the schematics of FIG. 1, the energy converter part of the apparatus comprises of a shat 123 centrally connected to the following:
a. A pairs of gears 112 and 113 to mate with rods; and centrally connected to the shaft 123 with rack and pinion in reverse direction to allow rotation of gears in the same direction while exerting force on the shaft. The gears spaced at certain distance from one another;
b. A flywheel comprising of a round tube filled with water or other liquid, in which the tube is divided into sections with barriers inside. The barriers inside the tube are for preventing the liquid inside the tube to turn, while the tube is turning. A set of valves connected in between the sectional barrier will remain open to allow the liquid to freely flow in all the sections while the tube is getting filled, and the valve closed while the tube is in rotation.
c. A turbine 107 centrally connected to the said shaft for generation of electricity.

Refereeing again to the schematics of FIG. 1 the rods 102 and 103 connected to the rod 104 to adopt the distance of the gears along the shaft. The rods 102 and 103 are placed in opposite direction of the shaft's circular motion line; a set of narrow blades 130 with slots attached to the rods to accommodate the distance of two gears along the center of the rotation of the shaft. The blades 130 with slots on their surface mate with the rack and pinion gears to allow the rotation of the shaft 123 in only one direction.
d. A hinge 115 and lock connecting the said first rod 104 to the second set of rods 102 and 103 to allow the plate to be pulled up from the water.
e. A pair of hinge and lock connected along the 102 and 103 rods to allow rods facing the gears at different angle for different diameter gears to get connected to the shaft for linear motion amplification purposes.

The FIG. 2 is for a different embodiment of the present invention, depicts the energy converter part 100 deployed on a pole 101 by mechanical means 111 wherein the pole is connected to the ocean floor vertically by means of 126. A buoyant body 117 is a floating on top of ocean water to provide the reciprocating motion in any direction in which it is anchored to the ocean floor. The buoyant body is connected to a semi rigid means 107 in which it passes through a ball bearing loop that is connected to the pole 101 and then it is connected to the rod 104. The rod is guided by support 105 for linear motions and connected to two other rods 102 and 103 the said rods connected to a narrow blade 115 with equidistance slots engaged with two gears 112 and 113. The two gears are connected to the shaft 123 such that when a plate moves in one direction, it forces the shaft to rotate in a direction and when the plate moves in opposite direction, it forces the shaft to move in the same direction; thus the reciprocating motion of the buoyant body is in opposite motion with respect to the point of anchor will cause a rotational force to the shaft and, thus rotating to a turbine providing electrical energy.

FIG. 3 is for a different embodiment of the present invention, depicts a converter 100 deployed on a pole 101 by mechanical means 111 wherein the pole is connected to the ocean floor by means of 126. A buoyant body 110 is floating on top of ocean water to provide the two dimensional motion. The buoyant body is connected to the rod 104. The rod is guided by support 105 in linear motions and connected to two other rods 102 and 103 with groves engaged with two gears 112 and 113. Two gears with teeth 129 are connected to the shaft 123 such that when the raft moves in one direction, it forces the shaft to rotate in a direction and when the raft moves in an opposite direction, it forces the shaft to move in the same direction; thus the reciprocating motion of the buoyant body is in opposite motion with respect to the point of anchor will cause a rotational force to the shaft and, thus rotating to a turbine providing electrical energy.

FIG. 4 is for a different embodiment of the present invention for ocean wave motion when the ocean floor is deep. In this embodiment, a frame 100 is mounted on a subsurface floatation platform inflatable air bag 138. The inflatable air bag is also connected to a flat plate 10 immersed into the body of ocean water. The frame 100 is supported by plurality of supporting rods 139. The air bag and the plate 10 are tethered to the ocean floor 5 using mooring cable 11 or a similar tether. A raft 20 floating on top of the ocean water surface and guided by supporting rods 139 transfers reciprocating motion to the first rod. In all other respects the apparatus is identical to that of the first embodiment described above.

FIG. 4, depicts the details of the shaft 123 allowing plurality of buoyant bodies activating the shaft. The second set of rods 102 and 103 is duplicated for each buoyant body tethered to the ground around the main converter 100, connected to it by a rope delivering mechanical energy to the shaft.

FIG. 5 is the drawing of the buoyant body, solid or inflatable air gag for its effectiveness in capturing energy from horizontal or near horizontal motion of the waves. The pouch like shape of a cavity under the buoyant body 201 will get opened to allow the rushing water to get penetrated inside the pouch in the direction of rushing water. One the umbrella shape mechanism 202 will get opened only in the direction of wave in any direction and the others will remain closed. Point 203 is where the buoyant body is tethered to the ocean floor, and attached to first rod 104 with a rope.

FIG. 6A is for a different embodiment of the present invention for generating electrical energy from reciprocating motions of land vehicles while they are being driven. The converter is connected to the frame of the vehicle and first rod is connected to a wheel or plurality of the vehicle wheels, to the first rod in parallel to the shock absorbers. Since the linear distance motions are small and the force is huge, the linear reciprocating motions are amplified to account for infinitesimal motion loses during the conversion. Although there are many different combination methods of linear motion energy amplification, and transfers, such as combination of circular, linear or electronics and number of converters, this embodiment is for only one of those methods.

FIGS. 6-B and 6-C are for one the embodiment of methods, to allow a single converter to receive plurality of energy capturing and amplification elements that the transferred to a main converter.

FIG. 6-B shows an oil filled 610 enclosure to capture and amplify linear motions that is deployed on a transportation vehicle frame 609; the first rod connected to the center of the rotation of one of the wheels such that the differential reciprocating motion of the wheel with respect to the frame is utilized to energize a turbine 107; the first rod is connected to the vehicle assembly that covers the center of the rotation of a wheel and to a square shape blade 603 with slots to get engaged with a first gear 605 to translate linear motion to rotation. Rotational motions are amplified by second set of double gears 606 and 608 that are centrally connected to each other and to the first gear by 615. The first gear 605 has a smaller radius compared to the second double gears to provide linear motion amplification. The rectangular shape blade 603 with slots is attached to the said first rod at one side to mate with the first gear in a housing; the second set of double gears 606 and 608 are space apart and situated on each side of the shaft 123 to mate with third set of double gears 611 and 613 at 90 degree; the center of the rotation of the third double gears connected to the said shaft 123 with a rack and pinion gear box 620, the third double gears are spaced apart to mate with the second set of double gears 606 and 609; such that the second double gear and the third set of the double gear form a rectangle. When the first gear rotates back and forth, it causes the shaft to rotate in only one direction. The shaft 123 is also connected with rack and pinions gear system 620 to receive plurality of reciprocating linear mechanical motions, from different wheels of the vehicle.

FIG. 6-C shows an oil filled enclosure 600 that is also connected to the frame of the vehicle; a square shape narrow blade 603 with slots to mate with a first gear 605 to translate linear motion to rotation. Rotational motions are amplified by second gear 606 that is centrally connected to the first gear while the first gear having smaller radius compared to the second gear 606 for motion amplification. A second set of square shape double blades 604 with slots are made to mate with the second gear at two sides of the second gear 606. The second set of the blades are connected to a set of semi rigid wires like a piano wire 607 and 608. The semi rigid wires are guided by plurality of ball bearing loops 611 to guide reciprocating motions of the piano wires. The semi rigid semi rigid wires transfer recuperation motions to the converter, such that the larger force of the motions caused by reciprocating motions of the blades are in the direction of the pull (rather than push) from one of the blades to the rack and pinion gears 620, causing the shaft to rotate in one direction. When first blade motion is in opposite direction, the second semi rigid wires exert a push force to the semi rigid wire. This is a smaller force that rotates rack and pinion in opposite direction of the larger force. The opposite push and pull of the semi rigid wires from the second set of rectangular blade causes rotation of the shaft in the same direction.

FIG. 7 is another embodiment of the present invention, for the converter to be deployed on ground or on a transportation land vehicle to receive motions from plurality of wind energy capturing elements to a main converter by a set of rope systems.

The converter part 100 is deployed on a vehicle 310 and is connected to a pole 310 that is connected to the vehicle via a spring 307. A buoyant body 301 that is a balloon is connected to the other side of the pole to swig back and forth by wind in a six degree of freedom. A pair of rope 305 and 306 connected to the balloon in 90 degree angle with respect to the center of the balloon that is connected to the pole 301, to transfer two dimensional motions of the balloon to a pair of first rods through a pair of ball bearing loop 308; to transfer reciprocating motions of the buoyant body caused by wind. Each first rod is connected to its corresponding second set of rods to rotate a corresponding pairs of gears connected to the shaft by rack and pinion. The linear motions are amplified similar to the FIG. 6B to allow capturing of small but powerful motions of a buoyant body such as a tree. The gears connected to the center of the shaft to rotate the shaft independent of the motions of other sets of gears such that when the buoyant body moves in three positive or negative directions (six degree of freedom), it forces the shaft to rotate in one direction and when the energy buoyant body moves in a negative three dimensional direction, it forces the shaft to move in same direction, causing reciprocating motion of the boat or the buoyant body to rotational motion of a turbine to generate electrical energy; while the remaining characteristics of the apparatus are the same.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus to be deployed on a sea vessel producing usable electrical energy while the vessel is in anchored position or in motion; said apparatus comprising of:
a. a buoyant body immersed in the body of the water and connected to a first rod; the first rod positioned to transfer linear reciprocating mechanical motional energy from ocean water to an energy conversion part;
the said first rod forced to slide in a linear mechanical guiding means connected to the body of the vessel allowing free linear motions of said rod caused by the buoyant body immersed in water, and acting as a damping mechanism; the a buoyant body forces the rod motions to be more stable compared to the up and down motions of the either sides of the vessel; the differences of the motions of the vessel and the a buoyant body will cause the reciprocating motions of the rods through the mechanical guides, such that the reciprocating motions of the vessel provides rotational motion of a shaft and a turbine to generate electrical energy, while the vessel is either in anchored position or in motion, moving from one place to another.
b. the said energy conversion part converts reciprocating motions, to axial rotational motions of the shaft; the center of rotation of the said shaft connected to an adjacent pair of rack and pinion gears, similar to a bicycle to allow the motion of the shaft in only one direction;
c. the said first rod connected to a second set of rods along the linear line of the first rod at distances equal to the diameter of the rack and pinion gears; the said pair of rods positioned at the opposite sides of the rotational line of the said shall; the said rods having equidistance sluts on their surface facing the center of the rotation of the said shall, such that the slots mate with the said rack and pinion gear to allowed rotation of the said gears and the said shaft in one direction;
d. a hinge and a lock is inserted along the second double rods to slightly bend to allow insertion of different diameter gears to be connected to the said shaft with rack and pinion;
unidirectional rotation of the said shaft takes place when the said rods move in reciprocating motions; in one direction, one of the rack and pinion gears is forced to move in a direction while there is no force to the second gear, in an opposite reciprocating motion there is no force exerted to the first gear while second gear is forced to rotate the shaft in the same direction; thus the reciprocating motions of the vessel provides rotational motion to the shaft to a turbine to generate electrical energy;

2. The provisions of claim 1 further a tube acting as a flywheel, axially connected to the said shaft and is divided into sections with a barrier separating each section such that when the tube is turning, the liquid inside the sections remain stationary with respect to the body of the tube; a set of valves means connected in between the sectional barriers to allow the tube getting filled with liquid when the valves are open position, allowing the liquid to flow to different sections freely and closed position when the tube is in rotation.

3. The apparatus of claims 1, wherein the converter part is deployed on a solid ground or on a pole; the said converter part is connected to a first rope connecting the converter part to a buoyant body or a boat; that said buoyant body or a boat are anchored to ocean bottom by a second rope; the said first rope passing through a ball bearing pulley, in turn connected to the said first rod to transfer reciprocating motions of the buoyant body or a boat caused by ocean water, such that when the buoyant body or the boat moves in three positive directions (six degree of freedom) around the point of anchor of the second rope, it forces the shaft to rotate in one direction and when the energy buoyant body or a boat moves in a negative three dimensional direction, it forces the shaft to move in same direction, causing reciprocating motion of the boat or the buoyant body to rotational motion of a turbine to generate electrical energy; provision is made to increase the weight of the first and the said second rod to return the buoyant body to the point of anchor; while the remaining characteristics of the apparatus are the same as claim 1.

4. The apparatus of claims 1 wherein the converter is positioned at the top of a pole and the pole is deployed on the low height ocean floor; the buoyant body is a raft connected to the first rod, guiding it up and down in the direction of the pole(s) through linear guiding means, thus transferring reciprocating motions of the raft to the said converter; the raft getting pushed in the direction of poles by the rise of the ocean wave and fall back due to its force of gravity, delivering reciprocating motion to the apparatus; while the remaining characteristics of the apparatus are the same as claim 1.

5. The apparatus of claim 3 wherein the buoyant body is a raft or an inflatable air bag; the said buoyant body's bottom contacting with ocean water, is also provided with plurality of pouch like foldable membranes to get opened in the direction of the horizontal or near horizontal motions of the wave, the said pouch like membranes allowing ocean water to get rushed in to force the buoyant body to move in six degree of freedom.

6. The apparatus of claim 1 wherein the energy converter part contained in a frame, standing on a buoyant subsurface support, in deep ocean water, the buoyant subsurface support, tethered to a deep ocean floor supporting the converter with a set of support rods forcing the frame extending above the corresponding ocean water surface in the vicinity of tethered point;
a rigid plate immersed in the ocean water and connected to the said buoyant subsurface support to provide stability of the frame with respect to the rising and falling of the ocean water; a second buoyant body floating on the ocean surface and freely guided by the sets of supporting poles, to rise and fall vertically or at an angle according to ocean wave motion, the second buoyant body interconnected with the said first rod for moving in reciprocating motion according to ocean wave motion; while the remaining characteristics of the apparatus are the same as claim 1.

7. The apparatus of claim 6 wherein the shaft is connected to a plurality of buoyant bodies; each buoyant body is tethered to an ocean floor by a rope and moving in six degree of freedom with respect to the converter part; each buoyant body connected to its corresponding first rod by a rope passing through a ball bearing pulley; each first rod is guided lineally and connected to its corresponding second set of rods to rotate a corresponding pairs of gears; all gears connected to the center of the said shaft to rotate the shaft independent of the motions of other sets of gears.

8. The apparatus of claims 1, wherein the converter part is deployed on a transportation vehicle frame and the said first rod connected to the wheel's differential such that the reciprocating motion of the wheel with respect to the frame is utilized to energize a turbine;
a) the first rod is connected to a wheel's differential and to an oil filled enclosure, containing components to amplify the small linear strokes of the wheel, which has large force to a large rotation and weaker rotational force of a second double gear; the said second double gear spaced apart to rotate in the same direction and rotational speed on two sides of the said shaft, is mated with the third set of double gears at 90 degree with respect to the line of rotations of the second set of double gear; the said third set of double gears are connected to the said shaft through a double rack and pinions such that the linear strokes of the first rod is amplified to a rotational motion of the shaft in one direction;
b) the said shaft is also connected through plurality of rack and pinions to plurality of gears to receive motions from other wheels of the vehicle;
other wheels of the vehicle, connected to a plurality of oil filled enclosures attached to the vehicle frame and a the said first rod connected to the to the wheel's differential, arranged for motion capture with the first rod; mechanical components or a servo motor are utilized for motion amplification and motion transfer to the said plurality of rack and pinion gears that causes the rotation of the shaft in the same direction to rotation of a turbine; while the remaining characteristics of the apparatus are the same as claim 1.

9. The apparatus of claims 1, wherein the converter part is deployed on a solid ground or on a transportation vehicle; the said converter part is connected to a pole that is connected to ground or the vehicle via a spring; a buoyant body such a balloon is connected to the other side of the said pole to swig back and forth by wind in a six degree of freedom; a pair of rope connected to the balloon in 90 degree angle with respect to the center of the balloon that is connected to the said pole, to transfer two dimensional motions of the balloon to a pair of first rods through a pair of ball bearing pulley; to transfer reciprocating motions of the buoyant body caused by wind; each first rod is connected to its corresponding second set of rods to rotate a corresponding pairs of double blades; all of blades connected to the center of the said shaft to rotate the shaft independent of the motions of other sets of blades such that when the buoyant body moves in three positive or negative directions (six degree of freedom), it forces the shaft to rotate in one direction and when the energy buoyant body moves in a negative three dimensional direction, it forces the shaft to move in same direction, causing reciprocating motion of the boat or the buoyant body to rotational motion of a turbine to generate electrical energy; while the remaining characteristics of the apparatus are the same as claim 1.

10. Provisions of the claim 1 wherein the buoyant body is a plate immersed in the ocean water; the said plate to be made of smooth surface with minimal thickness around its edges to provide minimal water drag to motion of the vessel; the said first rod and the second rod, connected to one another via a hinge and a lock for the first rod and the plate to be pulled out from the ocean water.
